(19) United States
(12) Patent Application Publication
(10) Pub. No.: US 2024/0227237 A1
(43) Pub. Date: Jul. 11, 2024

(54) ELECTROSPRAY EMITTERS, ASSOCIATED METHODS FOR THEIR USE, AND ASSOCIATED METHODS AND DEVICES FOR THEIR FABRICATION

(71) Applicant: Cornell University, Ithaca, NY (US)

(72) Inventors: Sadaf Sobhani, Ithaca, NY (US); Elaine Marie Petro, Ithaca, NY (US); Suhail Chamieh, Pasadena, CA (US)

(73) Assignee: Cornell University, Ithaca, NY (US)

(21) Appl. No.: 18/407,219

(22) Filed: Jan. 8, 2024

Related U.S. Application Data
(60) Provisional application No. 63/437,537, filed on Jan. 6, 2023.

(51) Int. Cl. B28B 7/34; B29C 64/124; B33Y 10/00; B33Y 80/00

(52) U.S. Cl. CPC B28B 7/346; B28B 7/342; B29C 64/124; B33Y 10/00; B33Y 80/00

(57) ABSTRACT

A method for fabricating a molded piece includes filling a mold with a slurry, curing the slurry in the mold to create a cured piece, and heating the mold, with the cured piece therein, to burn off the mold and a binder of the slurry. The mold is fabricated from a material that vaporizes at a temperature lower than the melting temperature of the molded piece, thereby ensuring that the molded piece maintains its shape while the mold and binder burns off. The mold may be fabricated from a resin or polymer using three-dimensional (3D) printing. The molded piece may be a porous ceramic electrospray emitter. To create this emitter with a sharp tip, at least part of the mold may be fabricated using 3D printing based on two-photon polymerization, which has a higher spatial resolution than other types of 3D printing.

### RELATED APPLICATIONS

This application claims priority to U.S. Provisional Patent Application No. 63/437,537, filed on Jan. 6, 2023 and titled “Methods of Making Ceramic Electrospray Emitters, Ceramic Electrospray Emitters, and Uses Thereof,” the entirety of which is incorporated herein by reference.

### BACKGROUND

An electrospray thruster is an electric propulsion device that operates by extracting and accelerating ions from a conductive liquid propellant through an applied electric field. An electrospray thruster may contain hundreds (or more) of ion-emitting units called electrospray emitters. Electrospray thrusters offer precise thrust control and high specific impulse, making them useful for satellite on-orbit precise attitude control and primary propulsion for small satellites (e.g., microsatellites). Other applications of electrospray emitters include focused ion beam etching and deposition and soft ionization mass spectrometry.

### SUMMARY

Many electrospray emitters are fabricated using subtractive manufacturing methods, such as electrochemical etching [1], deep reactive ion etching [2], and laser ablation [3]. With two-photon polymerization (TPP) printers, it is possible to achieve the microscale resolution necessary for fabricating electrospray emitters via additive manufacturing techniques. TPP is a non-linear process that uses a femtosecond pulsed laser beam to polymerize resin within the voxel of the laser, enabling the creation of three-dimensional (3D) features that are smaller than the diffraction limit of the laser beam [4].

Prior-art porous alumina emitters have demonstrated stable ion emission, with direct current recorded as a function of applied voltage (i.e., I-V measurements) between the emitter and a grounded extractor plate [5]. To characterize the emitter's ion plume, as well as its thrust and specific impulse, time-of-flight mass spectrometry (TOF-MS) is performed alongside emitted current measurements. By measuring the time it takes for charged particles from the emitter plume to travel a known distance, the mass-to-charge ratio of these species can be determined. Thrust can be inferred by accounting for the emitted current [6].

To produce stable ion emission at relatively low applied voltages, the emitter tip is made as sharp as possible. Prior-art methods of fabricating porous electrospray emitters use a slurry that is cured in a mold. Examples of these prior-art methods are described in U.S. Pat. Nos. 9,362,097, 9,478,403, and 9,837,237. One drawback of these prior-art methods is that removal of the electrospray emitters from the mold frequently damages the tips. An emitter with a damaged tip may produce less stable ion emission or a smaller ion emission, as compared to an emitter with an undamaged tip. Alternatively, a damaged tip may result in increased ion emission by producing multiple emission sites where various jagged edges have formed. In any case, the ion emission can vary greatly based on how, or if, the tip is damaged. This variability in ion emission and stability is a challenge for many applications, such as electrospray thrusters that use emitter arrays having up to thousands of tips, or more.

The present embodiments improve electrospray-emitter fabrication by physically separating the emitters from the mold without the need to apply a mechanical force that can damage the tips. In some of the present embodiments, a mold (with cured slurry therein) is heated to a temperature at which the mold is burned away and at which the binder in the slurry is evaporated away (i.e., debinding). The resulting molded piece has no part of the mold attached to it, and therefore it is no longer necessary to mechanically remove the piece from the mold. To achieve this result, the mold is fabricated with a material that burns away at a lower temperature than the melting point of the material forming the slurry particles. For many types of slurry (e.g., ceramic, glass, metal, silicate, etc.), a resin or polymer is a good material for the mold.

As an example of the present embodiments, a porous alumina electrospray emitter was fabricated using additive manufacturing processes. This emitter was then structurally analyzed using surface-science techniques. The emitter was fired under vacuum, during which its ion emission was characterized via plume diagnostic methods. More details about this experimental demonstration are presented below (see “Demonstration” in the Detailed Description).

The present embodiments include porous electrospray emitters, methods for fabricating these emitters, molds for fabricating these emitters, methods for fabricating these molds, and the use of these emitters in applications (e.g., electrospray or colloidal thrusters, electrospray ionization mass spectrometry, etc.). However, the present embodiments may be used for fabricating any kind of object, part, piece, or component that is made from a slurry. Accordingly, the present embodiments are not limited to electrospray emitters. Similarly, the present embodiments are not limited to ceramics, and may be used to fabricate parts made from metal, glass, silicate, and other materials. Similarly, the present embodiments are not limited to the fabrication of porous pieces, and may be used to fabricate non-porous pieces as well.

### BRIEF DESCRIPTION OF THE FIGURES

FIG. 1 is a perspective view of a substrate, in embodiments.

FIG. 2 illustrates a method for fabricating a porous electrospray emitter that uses the substrate of FIG. 1, in embodiments.

FIGS. 3A and 3B are images, taken with a scanning electron microscope, of a porous electrospray emitter fabricated with the method of FIG. 2.

FIG. 4A is an image, taken with a laser scanning confocal microscope, of the porous electrospray emitter.

FIG. 4B is a plot of the measured surface profile of the porous electrospray emitter.

FIG. 5 is a plot of the cross section of the measured surface profile.

FIG. 6 shows an experimental setup for testing the porous electrospray emitter.

FIG. 7 is a plot of the emitted current from the porous electrospray emitter, as a function of applied voltage. The shaded area represents one standard deviation.

FIG. 8 is a plot of the firing region of the plot of FIG. 7, plotted as absolute emitted current as a function of absolute applied voltage. The shaded areas represent one standard deviation.

FIGS. 9A and 9B are plots of time-of-flight data for the porous electrospray emitter operating in positive ion mode. The masses of the monomer, dimer, and trimer species are indicated.

FIGS. 10A and 10B are plots of time-of-flight data for the porous electrospray emitter operating in negative ion mode. The masses of the monomer, dimer, and trimer species are indicated.

FIG. 11 is a plot showing extended time-of-flight data for the porous electrospray emitter operating in positive ion mode. The masses of the monomer, dimer, and trimer species are indicated.

FIG. 12 is a flow chart of a method for fabricating a molded piece, in embodiments.

FIG. 13 is a side cross-section view of a porous electrospray emitter that has a non-uniform porosity, in embodiments.

FIG. 14 illustrates a method for fabricating an array of porous electrospray emitters, in embodiments.

### DETAILED DESCRIPTION

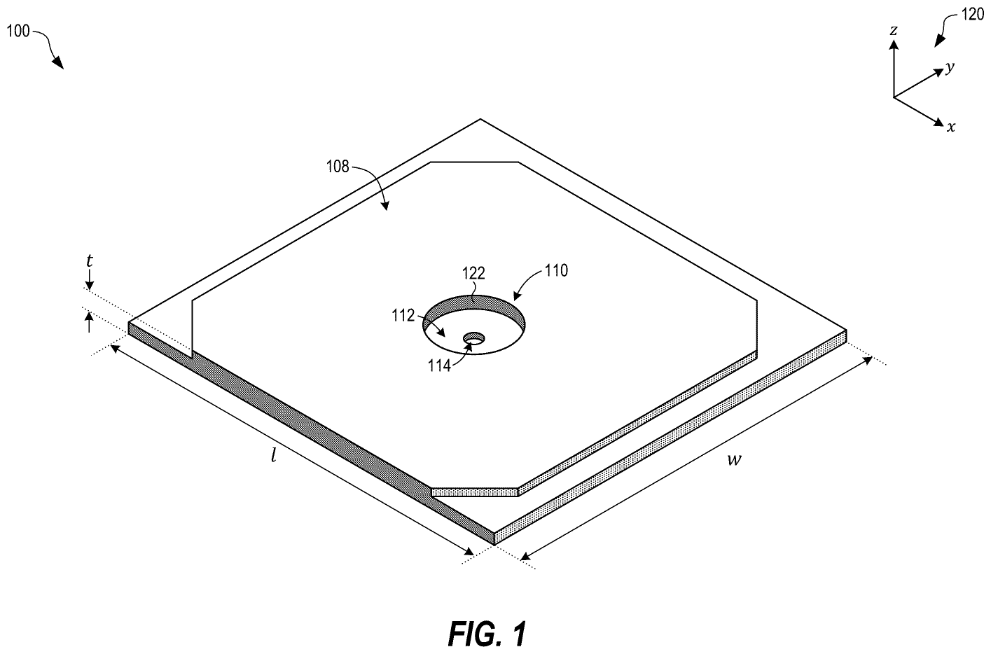

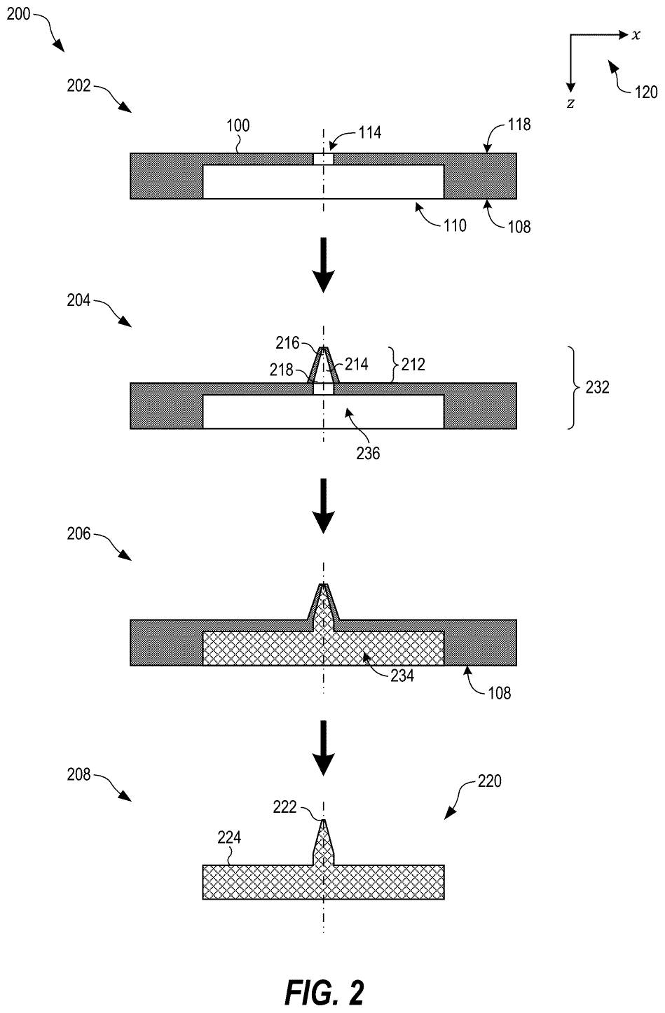

FIG. 1 is a perspective view of a substrate 100 that may be used with the present embodiments. The substrate 100 is shaped as a rectangle in the x-y plane (see right-handed Cartesian coordinate system 120), having a length l along x, a width w along y, and a thickness t along z. The substrate 100 forms a substrate cavity 110 that is shaped as a circular pocket 122 extending downward (i.e., in the −z direction) from a planar top face 108 of the substrate 100 to a planar internal face 112. Thus, the depth of the circular pocket 122 is less than the thickness t and the internal face 112 is parallel to the top face 108. At the center of the circular pocket 122 is a through hole 114 that extends from the internal face 112 downward to a planar bottom face 118 of the substrate 100 (see FIG. 2). Thus, the substrate cavity 110 is shaped as a stepped cylinder in which the circular pocket 122 has a larger diameter than the through hole 114.

The substrate cavity 110 may form any three-dimensional (3D) shape that both intersects with the planar top face 108 to form one or more top apertures, and that intersects with the planar bottom face 118 to form one or more bottom apertures. As described in more detail below, this shape allows slurry to pass through the substrate cavity 110 from the one or more top apertures to the one or more bottom apertures. In the example of FIG. 1, there is only one top aperture, which is shaped as the circle formed where the circular pocket 122 intersects the top face 108. As an alternative, the pocket 122 may be shaped as a square pocket, a rectangular pocket, or a different shape. In another example, the substrate cavity 110 forms several of the through hole 114, thereby creating several circular bottom apertures. These through holes 114, and therefore the corresponding bottom apertures, may be arranged as a one-dimensional or two-dimensional array (e.g., to create an array of ceramic electrospray emitters). The substrate cavity 110 may have a different shape without departing from the scope hereof.

The substrate 100 may be fabricated from a resin or polymer (e.g., a thermoplastic). The resin may be curable using light (e.g., ultraviolet (UV) light or light at 405 nm), heat, chemical additives, or a combination thereof. In some embodiments, the substrate 100 is fabricated using additive manufacturing processes. For example, the substrate 100 may be constructed with 3D printing. In other embodiments, the substrate 100 is fabricated using subtractive manufacturing processes. For example, the substrate may be constructed by cutting (e.g., laser cutting, waterjet cutting, mechanical cutting, etc.) a polymer sheet (e.g., acrylic) and forming the substrate cavity 110 therein by milling or drilling. In some embodiments, the substrate 100 is fabricated using a combination of one or more additive manufacturing processes and one or more subtractive manufacturing processes. While the term “additive manufacturing process” is used herein to include 3D printing, this term is also intended to include other processes, such as molding (e.g., injection molding, compression molding, etc.), casting (e.g., resin casting, die casting, etc.), thermoforming, and the like.

After the substrate 100 is shaped, it may be cleaned to remove excess resin and solvents. After cleaning and drying, the substrate 100 may be cured to harden it. For example, the substrate 100 may be cured by exposing it to a source of energy. For example, the substrate 100 may be exposed to UV light (e.g., from a light-emitting diode or gas-discharge lamp) for the case of UV-curable resin. As another example, the substrate 100 may be heated (e.g., on a hot plate or inside an oven) for the case of heat-curable epoxy resins. Other types of resins may be used with the present embodiments without departing from the scope hereof. These other types of resins may use other forms of energy for curing.

FIG. 2 illustrates a method 200 for fabricating a porous electrospray emitter 220 that uses the substrate 100 of FIG. 1, in accordance with some of the present embodiments. The method 200 is shown in FIG. 2 as a sequence of cross-section views with the +z direction pointing downward, opposite to the orientation of FIG. 1.

In step 202 of the method 200, the substrate 100 is fabricated (e.g., as described above with regards to FIG. 1). In step 204 of the method 200, a device mold 232 is fabricated by 3D printing an emitter mold 212 over the bottom face 118 of the substrate 100. The emitter mold 212 has a proximate end that is closer to the bottom face 118 and a distal end that is farther from the bottom face 118. The proximate and distal ends cooperate to create a conical cavity 214. The proximate end is shaped such that the conical cavity 214 forms a circular base 218 that coincides with the through hole 114 (i.e., the bottom aperture of the substrate cavity 110). The distal end is shaped such that the conical cavity 214 forms a tip 216. Accordingly, the conical cavity 214 and substrate cavity 110 are connected to each other (via the through hole 114) to form a continuous device cavity 236. The distal end of the emitter mold 212 does not form any hole that connects the conical cavity 214 to the region of space outside of the device mold 232. Accordingly, the conical cavity 214 can only be filled with slurry via the through hole 114.

Similar to the substrate 100, the emitter mold 212 may be fabricated using additive manufacturing processes, subtractive manufacturing processes, or any combination thereof. In particular, the emitter mold 212 may be created using 3D printing based on multi-photon polymerization, such as two-photon polymerization (TPP). Advantageously, TPP-based 3D printing can achieve a higher spatial resolution than other types of 3D printing. Accordingly, TPP-based 3D printing can produce the distal end of the emitter mold 212 such that the tip 216 is sharp enough that the resulting emitter 220 can form a Taylor cone and ionize a liquid propellant when a sufficient voltage is applied to it. The sharpness of a porous, conical, electrospray emitter tip is frequently characterized by its radius of curvature R_{C} [7]. For this type of emitter, R_{C} is typically tens of microns (e.g., 10-100 μm). However, the present embodiments include emitters, as well as their methods of manufacture and methods of use, whose tips have any value of R_{C}, including values of R_{C} less than 10 μm (e.g., 1 μm, or less) and values of R_{C} less than 100 μm (e.g., 250 μm, or more).

To enhance electrospray emission and reliability, a porous electrospray emitter is usually designed such that the radius of curvature R_{C} is as small as possible. However, the substrate 100 need not have features this small. Accordingly, the substrate 100 may be fabricated using a conventional 3D printing technique that does not have the high spatial resolution of TPP-based 3D printing. In this way, a faster and less expensive type of 3D printing (e.g., stereolithography, fused deposition modeling, selective laser sintering, etc.) is used to construct most of the device mold 232 while TPP-based 3D printing is used only for the part of the device mold 232 that benefits from the higher spatial resolution. Although there are benefits to combining different types of 3D printing, the device mold 232 may alternatively be fabricated using only one type of 3D printing.

In step 206 of the method 200, the device cavity 236 of the device mold 232 is filled with a slurry 234. As shown in FIG. 2, the slurry 234 may lie flush with the planar top face 108 of the substrate 100. The slurry 234 is a composition of matter that is a mixture of particles, binder, and one or more additives (e.g., dispersant). The particles may be glass, ceramic, metal, or any combination thereof. Examples of ceramic particles used to make ceramic slurries include, but are not limited to, alumina, titania, zirconia, and fused silica.

The device mold 232, with the slurry 234 filling the device cavity 236, may then be placed in a vacuum oven to remove air trapped in the slurry 234. The slurry 234 may then be exposed to energy (e.g., UV light or light at 405 nm) to cure it. In step 208 of the method 200, the device mold 232, with the cured slurry 234 therein, is heated to both burn off the device mold 232 and remove the binder (and other additives) of the slurry 234. After cooling, what remains is the porous electrospray emitter 220, including a tip 222 and a base 224. As can be seen in FIG. 2, no portion of the device mold 232 remains in contact with the emitter 220 after the step 208. At this point, the emitter 220 may be at least partially sintered.

### Demonstration

As an experimental demonstration of the method 200, a prototype of the device mold 232 of FIG. 2 was fabricated by 3D printing an emitter mold (e.g., the emitter mold 212 of FIG. 2) with IP-Q resin using a TPP-based 3D printer (Nanoscribe GT2) operating with a 10× objective lens. The emitter mold was printed onto a UV-cured resin substrate (e.g., the substrate 100 of FIG. 1) that was fabricated with an LCD 3D printer (Elegoo Mars 2 Pro). The prototype was bathed in 1-methoxy-2-propanol acetate (PGMEA) for three hours to remove excess resin, after which it was soaked in isopropyl alcohol for thirty minutes to remove the PGMEA. The prototype was dried with compressed air and placed in a 405-nm curing station for two minutes. Additional details about emitter fabrication can be found in Ref [5].

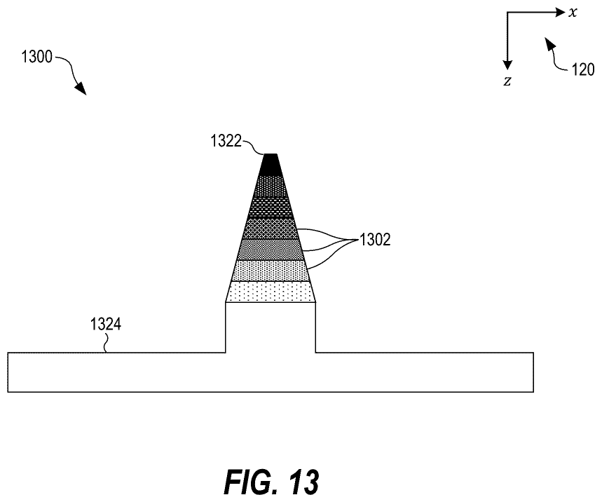

The substrate formed a circular pocket that acted as the mold for the emitter's base (see the base 224 in FIG. 2). The substrate surface in contact with the emitter mold contained a through hole (see through hole 114 in FIG. 1) through which the base mold (i.e., the substrate cavity 110 of FIG. 1) and the tip mold (i.e., the conical cavity 214 of FIG. 2) were filled as a single continuous volume (see the device cavity 236 in FIG. 2). After the prototype was printed and cured, a blunt 21G hypodermic needle was used to fill the continuous volume with commercial alumina slurry (AdmaPrint A130). The prototype, with the slurry therein, was placed in a desiccator to remove trapped air, after which it was exposed to UV light to cure the slurry. Consecutive slurry layers were applied, with vacuum and UV-curing steps repeated for each layer (see FIG. 13).

Once completely filled, the prototype (with the cured slurry therein) was placed in a Nabertherm muffle furnace to burn off the device mold (i.e., the base mold and emitter mold) and the binder of the slurry. The furnace was heated to 600° C. at a rate of 600° C./hr and held at this temperature for two hours. After it passively cooled to room temperature, the resulting emitter prototype was placed in a Nabertherm sintering furnace to partially sinter it, following a modified version of the slurry manufacturer's guidelines for alumina sintering. The sintering temperature peaked at 1400° C., a modification which allows the emitter to maintain its desired porosity [5].

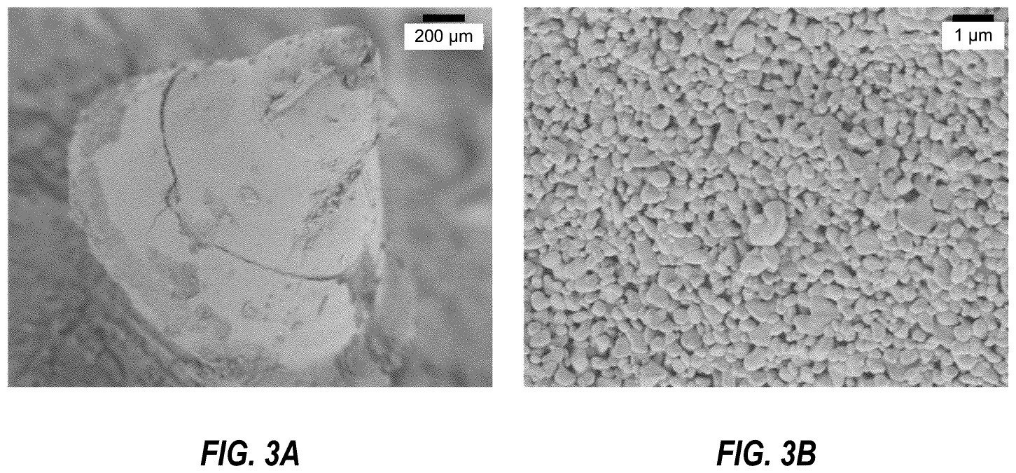

Once the prototype emitter was sintered, its external geometry and surface finish were characterized with a scanning electron microscope (SEM) and a laser confocal microscope (LCM). As shown in FIGS. 3A and 3B, the SEM (Zeiss LEO 1550) provided high-resolution images of the prototype emitter, enabling emitter surface analysis post-sintering and general visualization of the emitter's external geometry. The prototype emitter shown in FIGS. 3A and 3B was sintered at a maximum temperature of 1400° C. with dwell times matching the slurry manufacturer's guidelines for alumina sintering.

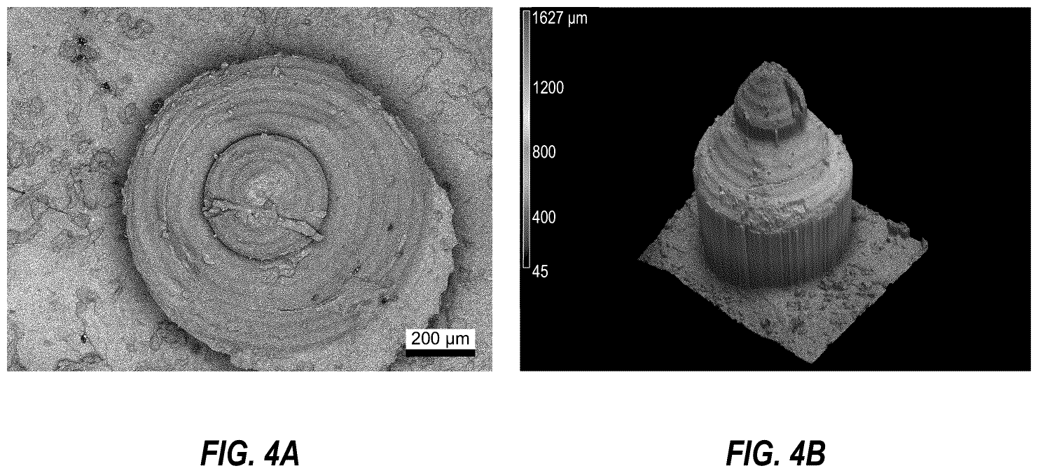

A laser scanning confocal microscope (LSCM) was also used to image the prototype emitter (see FIGS. 4A and 4B). The LSCM (Keyence VK-X260) provides a non-intrusive, nanometer-resolution method of imaging emitters at atmosphere, while also requiring less sample preparation than SEM imaging. The LSCM also possesses the ability to produce a 3D rendering of a sample when given a two-dimensional (2D) view of the sample (i.e., imaging the top of the sample). This is useful for visualizing the external geometry and surface finish of emitter tips. Because the laser can only accurately scan flat or convex surface features, additional LSCM or SEM imaging can be used to more precisely characterize the emitter's surface. However, the LSCM provides a rapid and convenient method for imaging emitters prior to using more labor intensive methods. Additionally, the LSCM has a laser profilometer that can produce a surface profile of the prototype emitter, which can be used to determine the prototype emitter's height, apex angle, and radius of curvature R_{C} of the tip.

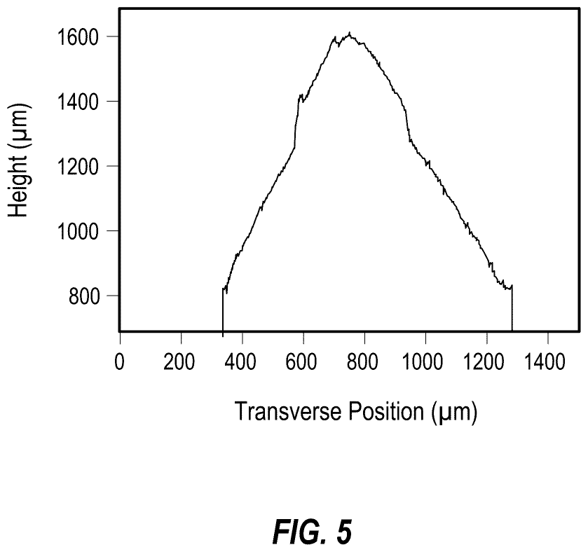

FIG. 5 is a plot of the surface cross-sectional profile of the prototype emitter. The surface profile shows that the emitter has a height of 1.6 mm. Image analysis of the emitter-surface profile indicates that the emitter has an apex half-angle of 33.0° and a radius of curvature R_{C} of 59.6 μm. The LSCM images and surface profile suggest the presence of defects and surface roughness on the emitter's tip. We hypothesize that these features developed due to interactions between the alumina slurry and emitter mold during the debinding phase of the fabrication process.

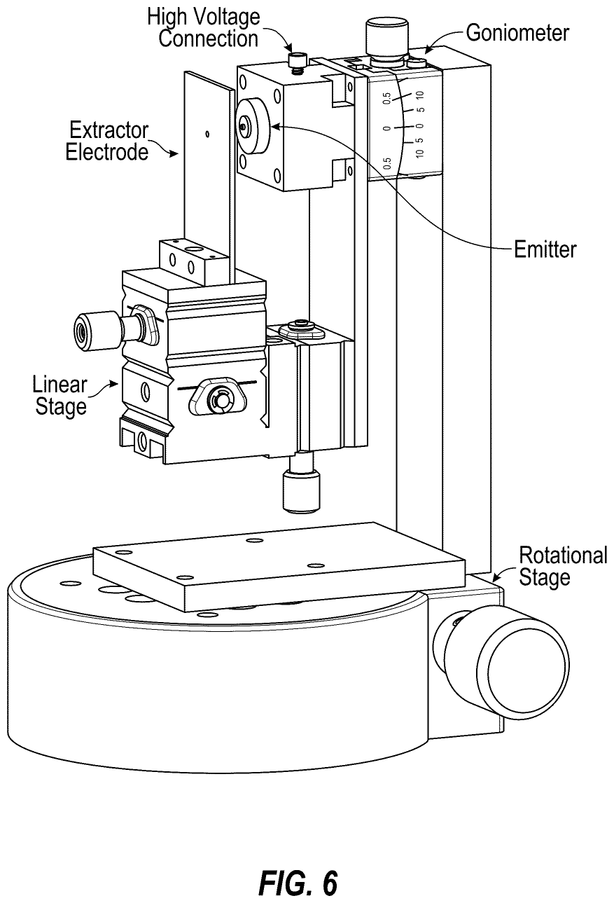

To characterize the electrical performance of the prototype emitter, it was held on a stainless-steel SEM stub with conducting carbon tape. The stub was securely fit into a 1″×1″×1″ polytetrafluoroethylene (PTFE) block using a set screw that also served as the high voltage connection point. A micropipette was used to drop approximately 0.5 μL of EMI-BF₄ onto the emitter tip, which was subsequently absorbed into the porous structure of the emitter. The PTFE block was mounted to a larger assembly (see FIG. 6) that included a precision three-axis linear stage for aligning the extractor electrode, a goniometer for controlling the pitch angle of the ion source, and a rotational stage for controlling the yaw angle. Tests were performed inside a 24″×20″ cylindrical vacuum chamber operated by a rotary vane backing pump and a turbo molecular pump. The background pressure for all testing was approximately 10⁻⁵ Torr.

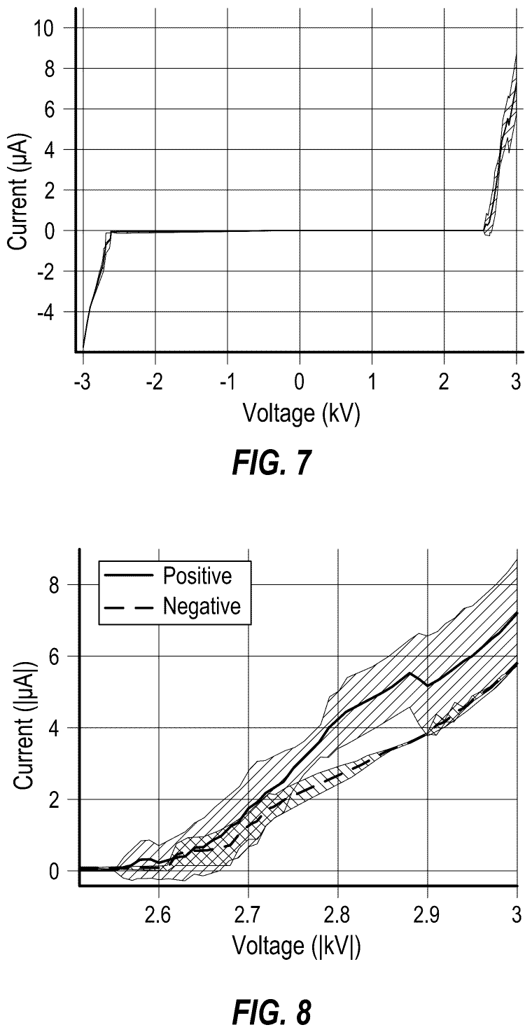

FIG. 7 is a plot the emitted current as a function of applied voltage (i.e., an I-V curve). FIG. 8 shows the firing region of the I-V curve expanded. The onset potential required to fire was +2.56 kV and −2.62 kV for the positive and negative modes, respectively. After the onset firing voltage is reached in the positive mode, the emitted current increases approximately linearly with voltage, at a rate of roughly 16.2 nA/V, with a maximum at 3 kV of 7.2 μA. In the negative mode, the emitted current decreases by roughly 14.7 nA/V with a minimum at −3 kV of −5.8 μA. These values of the current are relatively high for single electrospray emitters operating in the ion mode and may indicate multiple emission sites forming, possibly from defects near the emitter tip.

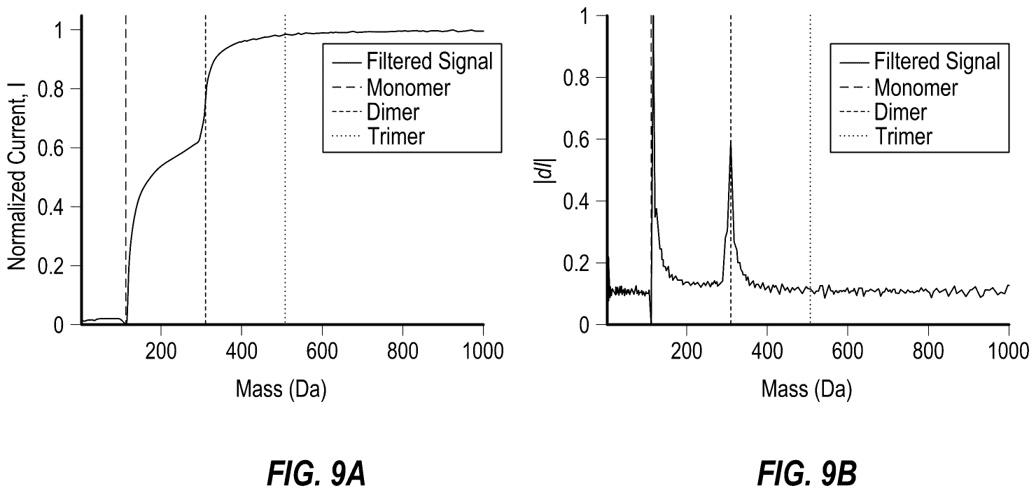

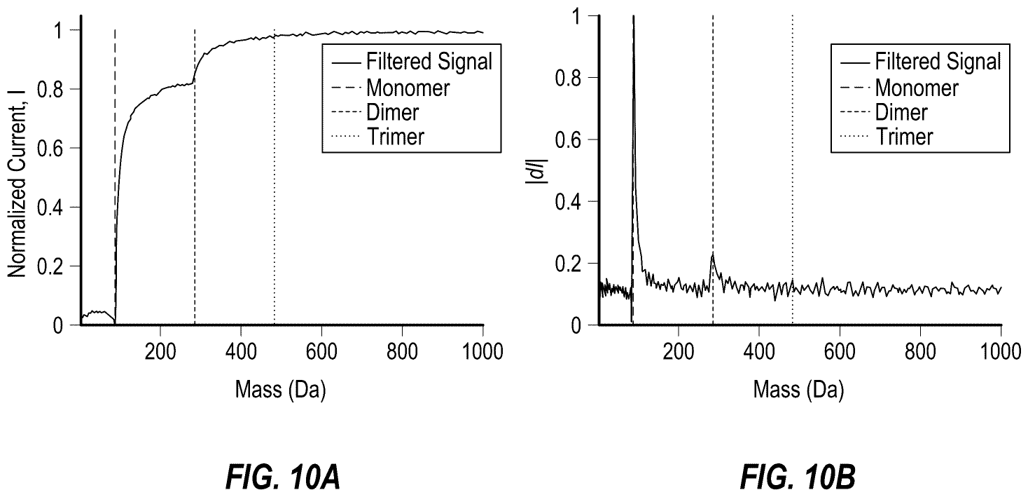

The time-of-flight (TOF) spectrum was collected in the positive and negative mode using a one-meter-long flight tube with a microchannel plate (MCP) at the end coupled with a transimpedance amplifier. The ion gate consisted of two parallel electrodes connected to a high-voltage power supply and controlled with a 20-MHz waveform generator (Keysight). Mass is reported assuming all species are singly charged. The data was smoothed using a third-order Savitzky-Golay filter. FIGS. 9A and 9B are plots of the TOF curve in the positive mode, indicating emission of primarily monomers (EMI⁺) and dimers ([EMI⁺][EMI-BF₄]). FIGS. 10A and 10B are plots of the TOF curve in the negative mode, showing a relatively larger monomer (BF₄⁻) population and only a sparse dimer ([BF₄⁻][EMI-BF₄]) population.

To drive the electrons generated in the MCP channels toward the output, a −1 kV potential was applied to the outer most plate; this makes collecting mass spectra of negative ions only possible when the ions have sufficient energy to overcome the −1 kV potential, and still enough energy to induce secondary electron emission at the MCP. The positive and negative ion plumes were fired at ±2.8 kV, which is sufficient for negative ion mass spectra collection.

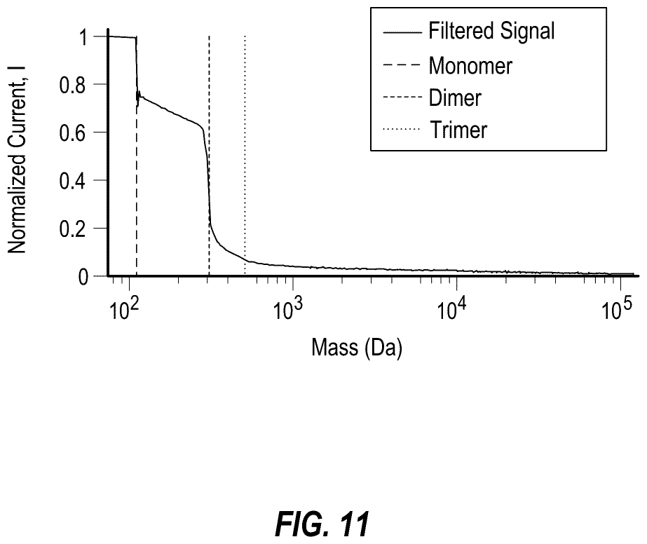

FIG. 11 shows the TOF curve in the positive mode for an extended collection period, allowing for the detection of much larger species. After the trimer species line, a gradual decrease in current is seen, indicating a population of more massive droplets mixed with the ion plume.

### Additional Embodiments

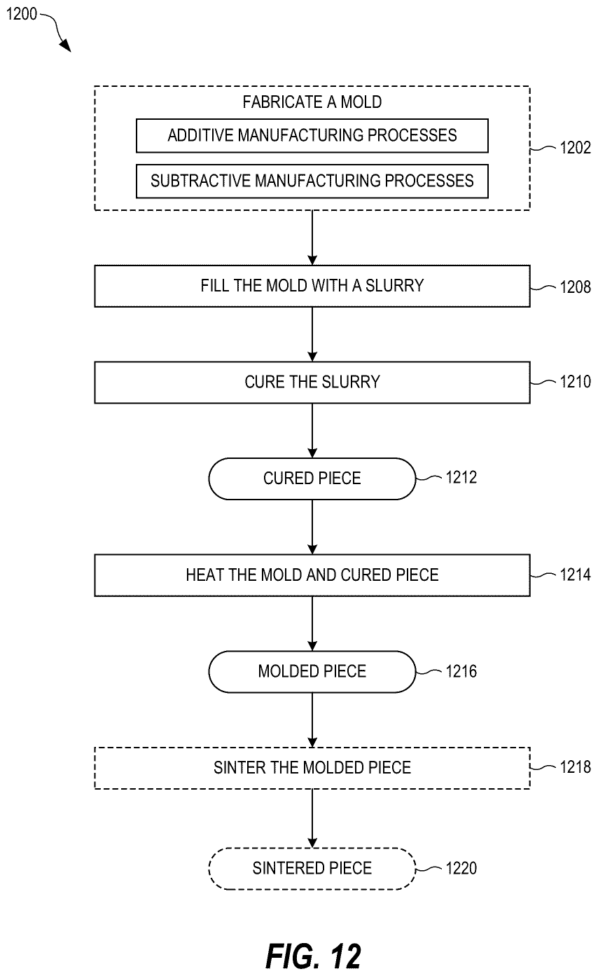

FIG. 12 is a flow chart of a method 1200 for fabricating a molded piece 1216, in accordance with some of the present embodiments. The method 200 of FIG. 2 is one example of the method 1200 for the case where the molded piece is a porous electrospray emitter. In step 1208 of the method 1200, a mold is filled with a slurry. The mold may be constructed from a resin or polymer. In one example of the step 1208, the slurry 234 of FIG. 2 is filled into the device cavity 236 of the device mold 232. The slurry may be a ceramic slurry, a metal slurry, a glass slurry, a silicate slurry, or a different type of slurry (or mixture of two or more different slurries) known in the art. When the slurry is a ceramic slurry, it may be an alumina slurry, a zirconia slurry, a titania slurry, a silicon carbide slurry, a silicon nitride slurry, or a combination thereof.

In step 1210 of the method 1200, the slurry is cured in the mold to create a cured piece 1212. In one example of the step 1210, the device mold 232 of FIG. 2 is placed, with the slurry 234 therein, into a vacuum oven (e.g., a desiccator) to remove air trapped in the slurry. The device mold 232, with the settled slurry 234 still therein, is then exposed to an energy source to cure the slurry 234, thereby hardening it. For example, the slurry 234 may be exposed to ultraviolet light for the case where the slurry 234 uses UV activation.

In step 1214 of the method 1200, the mold, with the cured piece 1212 therein, is heated to both burn off the mold and binder (and other additives that may be present) in the slurry. The result is the molded piece 1216. Thus, the mold is fabricated from a material that vaporizes at a lower temperature than the remaining material of the molded piece 1216 (i.e., the material of the slurry particles). For this reason, various resins and polymers are good choices for the mold material when the molded piece is ceramic, metal, glass, or silicate. In one example of the step 1214, the device mold 232 of FIG. 2 is heated (with the cured slurry 234 therein) in a furnace. The molded piece 1216 contains no portion of the mold attached thereto, and therefore does not need to be mechanically removed from (e.g., pried out of) the mold.

In some embodiments, the method 1200 further includes the step 1218, in which the molded piece is at least partially sintered to create a sintered piece 1220. In general, sintering is used to fuse the remaining slurry particles together without fully melting these particles. For partial sintering, gaps still exist between the slurry particles. The resulting sintered piece 1220 has an internal porous structure that can be wetted and used for transporting liquid. For full sintering, the slurry particles are fused together without any gaps therebetween. In this later case, the resulting sintered piece 1220 has no porosity. The present embodiments include methods for fabricating both porous and non-porous sintered pieces.

In other embodiments, the molded piece 1216 or the sintered piece 1220 includes one or more porous electrospray emitters having a porous internal structure (e.g., the porous electrospray emitter 220 of FIG. 2). These one or more porous electrospray emitters may be made of metal or ceramic. In these embodiments, the method 1200 may further include the step of wetting a porous internal structure of the one or more porous electrospray emitters with a propellant (e.g., an ionic liquid or molten metal). The method 1200 may further include the step of applying a voltage to the one or more porous electrospray emitters to emit ions from a tip of each of the one or more porous electrospray emitters.

In other embodiments, the method 1200 includes the step 1202, in which the mold is fabricated. As described above and shown in FIG. 12, the mold may be fabricated via one or more additive manufacturing processes (e.g., 3D printing), one or more subtractive manufacturing processes (e.g., cutting, milling, drilling), or any combination thereof. In some embodiments, at least part of the mold is fabricated using 3D printing based on multi-photon polymerization. In one example of the step 1202, the substrate 100 of FIG. 1 is fabricated using stereolithographic 3D printing and the emitter mold 212 of FIG. 2 is fabricated on the substrate 100 using 3D printing with TPP. In another example of the step 1202, the substrate 100 is fabricated using one or more subtractive manufacturing processes while the emitter mold 212 is fabricated on the substrate 100 using 3D printing with TPP.

FIG. 13 is a side cross-section view of a porous electrospray emitter 1300 that has a non-uniform porosity, in accordance with some of the present embodiments. The emitter 1300 is one example of the porous electrospray emitter 220 of FIG. 2. To increase capillary flow of liquid propellant through its internal volume, the emitter 1300 has a porosity that decreases when moving from a base 1324 of the emitter 1300 to a tip 1322 of the emitter (i.e., in the −z direction). Equivalently, the emitter 1300 has a pore-size gradient such that relatively smaller pores are located closer to the tip 1322 and relatively larger pores are located closer to the base 1324. The enhanced capillary flow is passive and may help remove the need for active pressurization systems commonly used with non-porous electrospray emitters.

In the example of FIG. 13, the porous electrospray emitter 1300 is formed from a stack of layers 1302. While FIG. 13 shows the emitter 1300 having seven layers 1302, the emitter 1300 can alternatively have a different number of layers 1302. Each of the layers 1302 has a uniform pore size that is smaller than that of the layer 1302 beneath it and greater than that of the layer 1302 above it. Thus, the porosity of the emitter 1300 changes stepwise when moving from the base 1324 to the tip 1322, approximating a pore-size gradient along z. While FIG. 13 shows the seven layers 1302 having the same thickness, the layers 1302 may have different thicknesses.

The porous electrospray emitter 1300 may be fabricated by repeating the steps of filling (i.e., the step 1208 of the method 1200) and curing (i.e., the step 1210 of the method 1200) for each of the layers 1302. In this case, the mold is filled only with enough slurry to form a single new layer, after which the mold (with the cured piece 1212 and new layer of slurry therein) is processed to cure the new layer such that it becomes a hardened layer 1302 that is integrated with the cured piece 1212. To produce a pore-size gradient, a different slurry (e.g., made with particles of different size) is used for each new layer.

The present embodiments include porous electrospray emitters, and their fabrication methods, having any type of pore-size gradient. For example, a porous electrospray emitter may have a uniform porosity (i.e., a pore-size gradient that is constant along z). Such an emitter may be fabricated by performing the steps of filling and curing only once and using only one type of slurry. Other types of pore-size gradients include, but are not limited to, pore sizes that vary linearly along z, pore sizes that vary nonlinearly (e.g., quadratically) along z, and pore sizes that vary according to a piecewise function along z.

In certain embodiments, the porous electrospray emitter 220 has an average pore size that lies in the range of 1 nm to 10 μm, inclusive. In some of these embodiments, the average pore size lies within a subrange of values that falls entirely within the range of 1 nm to 10 μm. In certain embodiments, the porous electrospray emitter 220 has an average grain size that lies in the range of 1 nm to 10 μm, inclusive. In some of these embodiments, the average pore size lies within a subrange of values that falls entirely within the range of 1 nm to 10 μm. In certain embodiments, the porous electrospray emitter 220 has a porosity that lies in the range of 0% to 60%, by volume. In some of these embodiments, the porosity lies within a subrange of values that falls entirely within the range of 0% to 60%, by volume.

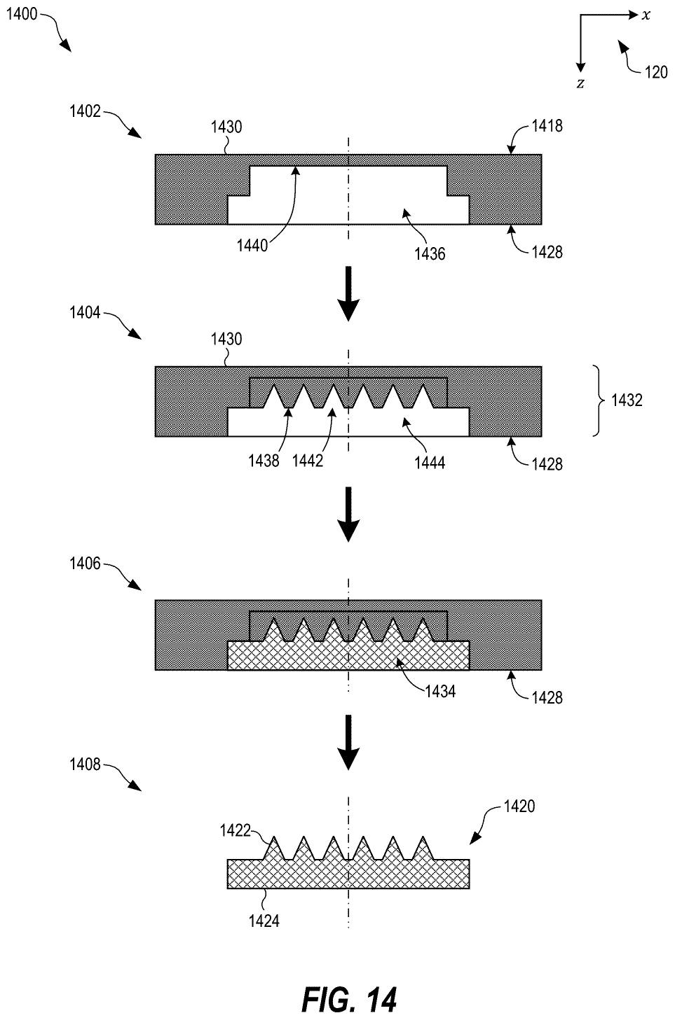

FIG. 14 illustrates a method 1400 for fabricating an emitter array 1420, in accordance with some of the present embodiments. The method 1400 is similar to the method 200 of FIG. 2 except that it uses a substrate 1430 forming a substrate cavity 1436 that does not pass entirely through the substrate 1430. Like FIG. 2, the method 1400 is shown in FIG. 14 as a sequence of cross-section views with the +z direction pointing downward.

The emitter array 1420 includes a base 1424 and a plurality of conical-shaped porous electrospray emitters 1422 that extend along x and have bases joined to the base 1424. In this case, the emitters 1422 form a one-dimensional array. However, the emitter array 1420 may include additional emitters 1422 extending along y, in which case the emitters 1422 form a two-dimensional array. In another embodiment, there is only a single emitter 1422. Thus, the method 1400 may be used to fabricate single electrospray emitters in addition to the emitter array 1420.

In step 1402 of the method 1400, the substrate 1430 is fabricated. The substrate 1430 may be fabricated similarly to the substrate 100 (e.g., 3D printing) and using similar materials as the substrate 100, as described above. The substrate cavity 1436 is shaped as a pocket that extends in the −z direction from a planar top face 1428 of the substrate 1430 to a planar internal face 1440. The substrate cavity 1436 does not extend all the way through the substrate 1430 and therefore does not form any apertures with a planar bottom face 1418 of the substrate 1430. In the x-y plane, the substrate cavity 1436 may be circular, rectangular, or a different shape.

In step 1404 of the method 1400, a device mold 1432 is fabricated by 3D printing an array mold 1438 within the substrate cavity 1436 and on the planar internal face 1440. The array mold 1438 forms an array of conical cavities 1442 shaped to complement the electrospray emitters 1422. The remaining volume of the substrate cavity 1436 forms a device cavity 1444. The array mold 1438 does not extend to the planar top face 1428, ensuring there is sufficient room within the device cavity 1444 to receive slurry that forms the base 1424 of the emitter array 1420. Like the emitter mold 212 of FIG. 2, the array mold 1438 may be fabricated using multi-photon polymerization, such as TPP, or another manufacturing process (additive, subtractive, or a combination thereof) that can produce the tips of the emitters 1422 with high spatial resolution.

In step 1406 of the method 1400, the device cavity 1444 is at least partially filled with a slurry 1434. As shown in FIG. 14, the slurry 1434 may lie flush with the planar top face 1428. The device mold 1432, with the slurry 1434 at least partially filling the device cavity 1444, may then be placed in a vacuum oven to remove air trapped in the slurry 1434. The slurry 1434 may then be exposed to energy to cure it.

In step 1408 of the method 1400, the device mold 1432, with the cured slurry 1434 therein, is heated to both burn off the device mold 1432 and remove the binder (and other additives) of the slurry 1434. As can be seen in FIG. 14, no portion of the device mold 1432 remains in contact with the emitter array 1420 after the step 1408. At this point, the emitter array 1420 may be at least partially sintered.

While the method 200 of FIG. 2 could be used to fabricate the emitter array 1420, the method 1400 may result in lower thermal stress during the step 1408, as compared to the corresponding step 208 of the method 200. This lower stress advantageously reduces the fraction of the emitter tips that break. Another advantage of the method 1400 is that the emitters 1422 may be located closer to each other. By comparison, the spatial separation between neighboring emitters in FIG. 2 would be limited by the lower spatial resolution of the 3D printing process (or other manufacturing process) used to fabricate the substrate 100.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### REFERENCES

[1] P. Lozano and M. Martinez-Sánchez, “Ionic liquid ion sources: characterization of externally wetted emitters,” J. Colloid Interface Sci. 282, pp. 415-421 (2005).
[2] L. F. Velasquez-Garcia, A. I. Akinwande, and M. Martinez-Sanchez, “A Micro-Fabricated Linear Array of Electrospray Emitters for Thruster Applications,” J. Microelectromech. Syst. 15, pp. 1260-1271 (2006).
[3] J. V. MacArthur, “Material and fabrication developments in the ion-electrospray propulsion system,” Ph.D. thesis, Massachusetts Institute of Technology (2020).
[4] S. Maruo, O. Nakamura, and S. Kawata, “Three-dimensional microfabrication with two-photon-absorbed photopolymerization,” Opt. Lett. 22, pp. 132-134 (1997).
[5] S. Chamieh, E. Petro, and S. Sobhani, “Additive Manufacturing and Characterization of Porous Ceramic Electrospray Emitters,” AIAA SCITECH 2023 Forum, p. 0261 (2023).
[6] C. T. Lyne, M. F. Liu, and J. L. Rovey, “A Low-Cost Linear Time-of-Flight Mass Spectrometer for Electrospray Propulsion Diagnostics,” The 37th International Electric Propulsion Conference, Cambridge, MA (2022).
[7] A. A. Gorodetsky, C. B. Whittaker, A. Szulman, and B. Jorns, “Robust Design of Electrospray Emitters,” AIAA Propulsion and Energy 2021 Forum (2021).

What is claimed is:

1. A method for fabricating a molded piece, comprising:
filling a mold with a slurry;
curing the slurry in the mold to create a cured piece; and
heating the mold, with the cured piece therein, to burn off the mold and a binder of the slurry.

2. The method of claim 1, wherein the slurry is a ceramic slurry, a metal slurry, a glass slurry, or a combination thereof.

3. The method of claim 2, wherein the slurry is an alumina slurry, a zirconia slurry, a titania slurry, a fused silica slurry, a silicate slurry, or a combination thereof.

4. The method of claim 1, wherein:
said filling the mold comprises filling a cavity with the slurry, the cavity extending downward from a planar top surface of a substrate; and
said heating the mold comprises heating the substrate, with the cured piece therein, to burn off the substrate and the binder.

5. The method of claim 4, the cavity comprising:
a cylindrical cavity extending downward from the planar top surface of the substrate; and
a conical cavity connected to a bottom face of the cylindrical cavity.

6. The method of claim 5, a base of the conical cavity coinciding with the bottom face of the cylindrical cavity.

7. The method of claim 5, a base of the conical cavity connecting to the bottom face of the cylindrical cavity via a cylindrical volume.

8. The method of claim 1, the mold comprising a resin, a polymer, or a combination thereof.

9. The method of claim 1, further comprising at least partly sintering the molded piece.

10. The method of claim 1, wherein said curing comprises:
placing the mold, with the slurry therein, in a vacuum oven to remove air trapped in the slurry; and
exposing, after the air trapped in the slurry has been removed, to energy.

11. The method of claim 1, further comprising repeating said filling and said curing to create the cured piece as a stack of layers.

12. The method of claim 1, further comprising fabricating the mold via (i) additive manufacturing or (ii) a combination of additive manufacturing and subtractive manufacturing.

13. The method of claim 12, wherein said fabricating the mold comprises constructing at least part of the mold with three-dimensional printing.

14. The method of claim 13, wherein said constructing comprises constructing at least part of the mold with three-dimensional printing based on two-photon polymerization.

15. The method of claim 13, wherein said constructing comprises:
three-dimensional printing with stereolithography to create a substrate forming (i) a cylindrical cavity that extends downward from a planar top surface of the substrate and (ii) a through hole passing downward through a center of the cylindrical cavity, the through hole forming a circular aperture in a planar bottom surface of the substrate; and
three-dimensional printing with two-photon polymerization to create a conical mold over the circular aperture such that a circular base of the conical mold coincides with the circular aperture.

16. The method of claim 13, wherein said constructing comprises:
creating a substrate using subtractive manufacturing, the substrate forming (i) a cylindrical cavity that extends downward from a planar top surface of the substrate and (ii) a through hole passing downward through a center of the cylindrical cavity, the through hole forming a circular aperture in a planar bottom surface of the substrate; and
three-dimensional printing with two-photon polymerization to create a conical mold over the circular aperture such that a circular base of the conical mold coincides with the circular aperture.

17. The method of claim 1, the molded piece being porous.

18. The method of claim 1, the molded piece comprising one or more porous electrospray emitters.

19. The method of claim 18, further including wetting a porous internal structure of the one or more porous electrospray emitters with an ionic liquid or molten metal.

20. The method of claim 19, further comprising applying a voltage to the one or more porous electrospray emitters to emit ions from a tip of each of the one or more porous electrospray emitters.
